(19) United States
(12) Patent Application Publication
(10) Pub. No.: US 2023/0383945 A1
(43) Pub. Date: Nov. 30, 2023

(54) GAS STOVE STRUCTURE CAPABLE OF PREVENTING CARBON DEPOSITION

(71) Applicant: Fu-Du FENG, Taipei City (TW)

(72) Inventor: Fu-Du FENG, Taipei City (TW)

(21) Appl. No.: 17/852,943

(22) Filed: Jun. 29, 2022

(30) Foreign Application Priority Data
May 31, 2022 (CN) 202221341016.5

(51) Int. Cl. F23D 14/04; F23Q 9/08

(52) U.S. Cl. CPC F23D 14/04; F23Q 9/08

(57) ABSTRACT

A gas stove structure capable of preventing carbon deposition includes a control box, an extending support frame, and a carbon-deposition-preventing gas burner. The control box includes a control box housing and a gas controller. The gas controller has a gas input end, a main-flame gas output end, and a gas operation unit for controlling the state of communication between the gas input end and the main-flame gas output end. The extending support frame is provided with a burner opening at one end. The carbon-deposition-preventing gas burner has a main-flame burner box provided on the inner side of the burner opening, an incoming-gas guide tube in communication with the main-flame burner box, and a main-flame gas nozzle provided at the gas inlet of the incoming-gas guide tube. The gas stove structure can effectively prevent carbon deposition attributable to long-term or intensive use of the gas stove.

### BACKGROUND OF THE INVENTION

### 1. Technical Field

The present invention relates to a gas stove structure capable of preventing carbon deposition. More particularly, the invention relates to a gas stove structure that can prevent carbon deposition and be applied to a ceramic oven for use, for example, in an outdoor barbecue held as a family gathering.

### 2. Description of Related Art

For environmental protection, and in order to prevent the inconveniences and pollution associated with the cleaning of used charcoal, some of the ceramic ovens on the market have used a gas stove instead of charcoal as their heat source. The burner of a conventional gas stove, however, is composed of one or a plurality of flame holes/nozzles, where carbon deposition tends to take place after long-term or intensive use of the gas stove. The carbon deposit not only has a negative effect on broiling, but also may result in incomplete combustion of gas.

### BRIEF SUMMARY OF THE INVENTION

The present invention provides a gas stove structure that can prevent carbon deposition. The invention is mainly intended to solve the problem of carbon deposition on a gas stove that has been used for a long time or intensively.

The present invention provides a gas stove structure capable of preventing carbon deposition. The gas stove structure includes a control box, an extending support frame, and a carbon-deposition-preventing gas burner. The control box includes a control box housing configured to cover an oven opening and a gas controller provided in the control box housing. The gas controller has a gas input end extending out of the control box housing, a main-flame gas output end, and a gas operation unit having an operation end provided on the control box housing, wherein the gas operation unit is configured to control the state of communication between the gas input end and the main-flame gas output end. The extending support frame is a box with a plurality of vent holes. The extending support frame is coupled at one end to the inner side of the control box housing and is provided at the opposite end with a burner opening. The carbon-deposition-preventing gas burner has: a main-flame burner box provided on the inner side of the burner opening, with the top side of the main-flame burner box formed with a plurality of flame holes; an incoming-gas guide tube provided on one side of the main-flame burner box and in communication with the main-flame burner box; and a main-flame gas nozzle provided at the gas inlet of the incoming-gas guide tube and in communication with the main-flame gas output end.

Implementation of the present invention can produce at least the following advantageous effects:
1. Carbon deposition on a gas stove can be prevented; and
2. The area of contact between the burning flames of a gas stove and air is increased to reduce carbon deposition and enhance broiling performance.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a gas stove structure capable of preventing carbon deposition according to the present invention, wherein the gas stove structure is applied to a ceramic oven;

FIG. 2 is a top view of the interior of the ceramic oven in FIG. 1;

FIG. 3 is a sectional view taken along line A-A in FIG. 1;

FIG. 4 is an exploded perspective view of the gas stove structure capable of preventing carbon deposition in FIG. 1; and

FIG. 5 is another exploded perspective view of the gas stove structure capable of preventing carbon deposition in FIG. 1.

### DETAILED DESCRIPTION OF THE INVENTION

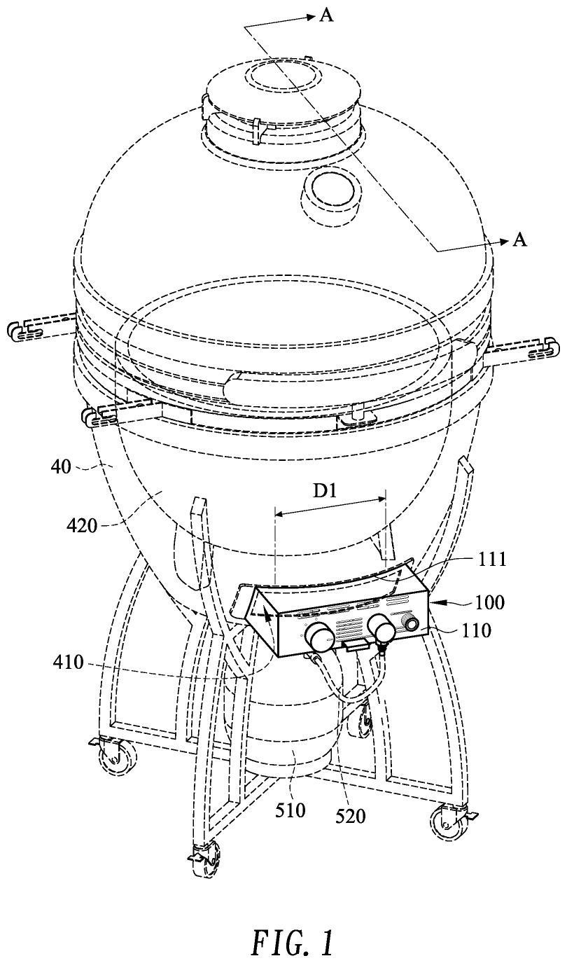

According to an embodiment of the present invention as shown in FIG. 1 to FIG. 5, a gas stove structure 100 capable of preventing carbon deposition is applied to a ceramic oven 40 and includes a control box 10, an extending support frame 20, and a carbon-deposition-preventing gas burner 30. The control box 10 includes a control box housing 110 and a gas controller 120. The control box 10 is configured to be coupled to the oven opening 410 in a lower portion of the ceramic oven 40.

The control box housing 110 can be adapted to the oven opening widths D1 of, and thereby allowed to completely cover, the oven openings 410 of ovens 40 of different brands and specifications. One side of the control box housing 110 may be a curved structure 111 matching the outer configuration of the oven 40 in order to be connected to the oven 40 tightly in a compliant manner.

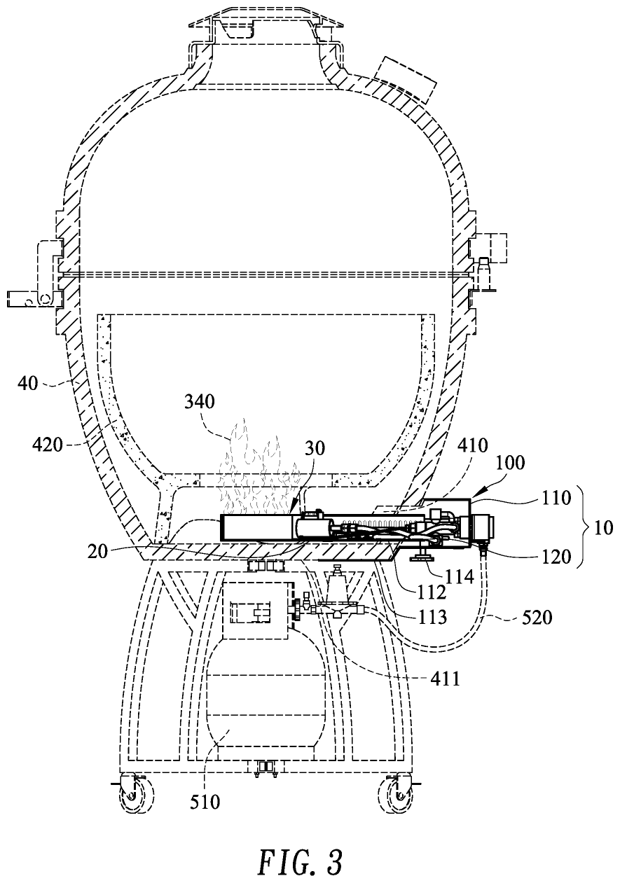

As shown in FIG. 3, the control box housing 110 has a housing bottom side 112 provided with a fixing clamp plate 113 so that the gas stove structure 100 capable of preventing carbon deposition can be coupled to the oven 40 securely. The fixing clamp plate 113 may be coupled to the housing bottom side 112 by way of a turning knob 114. Once the oven bottom side 411 of the oven 40 is clamped between the fixing clamp plate 113 and the housing bottom side 112, the gas stove structure 100 capable of preventing carbon deposition is coupled to the oven 40 firmly.

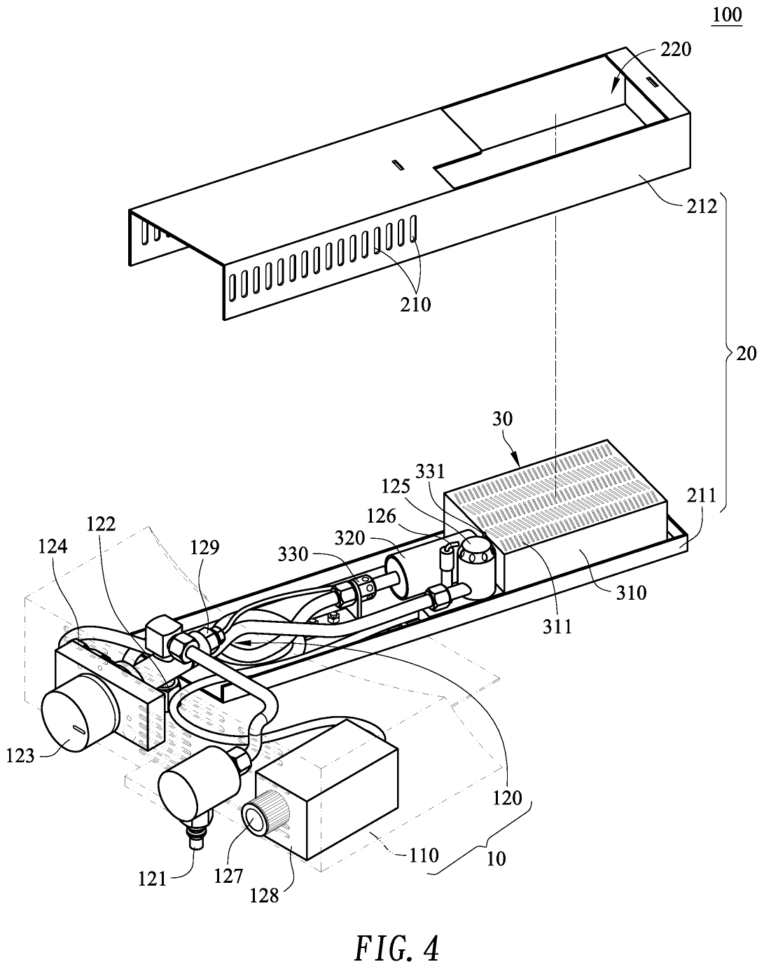

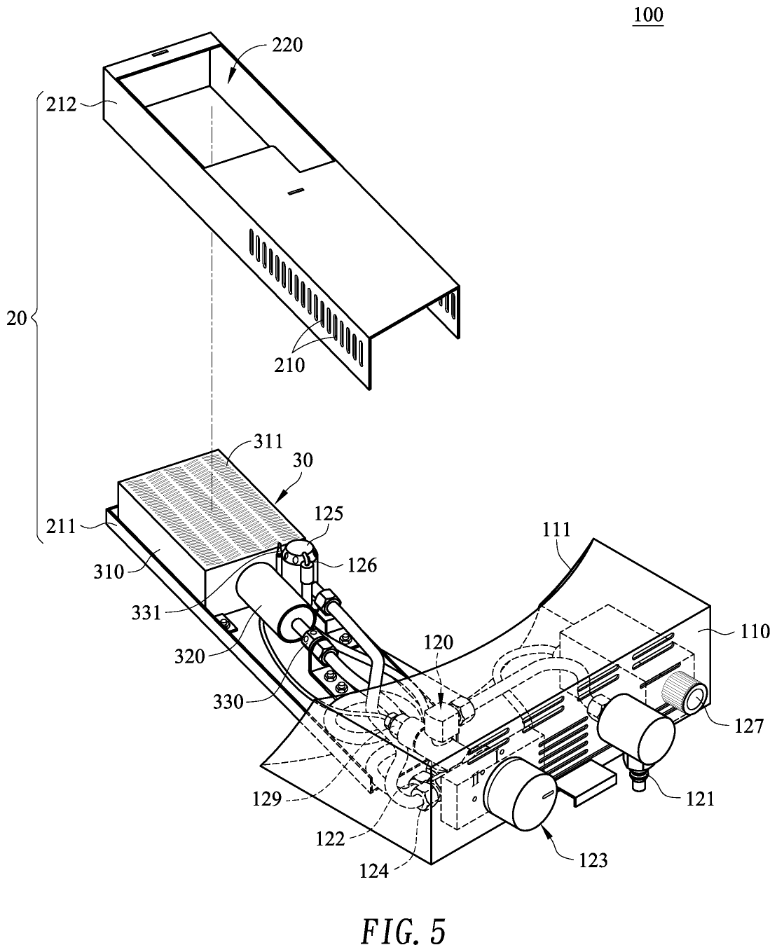

As shown in FIG. 4 and FIG. 5, the extending support frame 20 is a supporting frame 211 with a supporting frame housing 212. The supporting frame housing 212 is formed with a plurality of vent holes 210 to increase the intake of oxygen during combustion. One end of the extending support frame 20 is coupled to the inner side of the control box housing 110. The opposite end of the extending support frame 20, i.e., the end facing away from the control box housing 110, is provided with a burner opening 220. The extending support frame 20 allows the carbon-deposition-preventing gas burner 30 to extend to a central portion of the oven 40 effectively.

The gas controller 120 is provided in, and thus protected by, the control box housing 110. The gas controller 120 at least has a gas input end 121, a main-flame gas output end 122, and a gas operation unit 123. The gas input end 121 extends out of the control box housing 110 to make it easy for a user to connect an external gas cylinder 510 to the gas input end 121 through a gas hose 520.

The gas operation unit 123 has an operation end provided on the control box housing 110. The gas operation unit 123 is configured to control the state of communication between the gas input end 121 and the main-flame gas output end 122. For example, communication between the gas input end 121 and the main-flame gas output end 122 can be cut off by turning the gas operation unit 123 clockwise to the greatest extent, and restored by turning the gas operation unit 123 counterclockwise.

The gas controller 120 may further have a pilot-flame gas output end 124, the gas operation unit 123 may be further configured to control the state of communication between the gas input end 121 and the pilot-flame gas output end 124, and a pilot-flame burner 125 in communication with the pilot-flame gas output end 124 may be provided on a lateral side of the main-flame burner box 310 of the carbon-deposition-preventing gas burner 30.

When the gas controller 120 has the pilot-flame gas output end 124, the operation of the gas operation unit 123 is changed as follows: turning the gas operation unit 123 clockwise to the greatest extent will cut off communication between the gas input end 121, the main-flame gas output end 122, and the pilot-flame gas output end 124; turning the gas operation unit 123 counterclockwise to a first open stage I will restore the communication between the gas input end 121 and the pilot-flame gas output end 124; and turning the gas operation unit 123 counterclockwise again to a second open stage II will restore the communication between the gas input end 121, the main-flame gas output end 122, and the pilot-flame gas output end 124.

In other words, the first open stage I and the second open stage II are the pilot-flame control stage and the main-flame control stage of the gas operation unit 123 respectively. The first open stage I is used to allow or cut off the output of gas, or control the amount of gas output, from the pilot-flame gas output end 124 of the gas controller 120 to the pilot-flame burner 125. The second open stage II is used to allow or cut off the output of gas, or control the amount of gas output, from the main-flame gas output end 122 of the gas controller 120 to a main-flame gas nozzle 330.

In order for the gas stove structure 100 capable of preventing carbon deposition to carry out effective ignition, an electronic ignitor 126 may be provided on a lateral side of the pilot-flame burner 125, and in order to facilitate user operation, the control box housing 110 may be further provided with an automatic ignition switch 127. The automatic ignition switch 127 is configured to control an automatic ignition device 128 in the control box housing 110 and thereby make the electronic ignitor 126 ignite the gas coming out of the pilot-flame burner 125. The automatic ignition device 128 is an ignition device with a dedicated ground wire so as to have a steady pulse frequency.

When the gas operation unit 123 is in the first open stage I, the pilot-flame gas output end 124 is opened, and a relatively small amount of gas is delivered to the pilot-flame burner 125. If the automatic ignition device 128 is activated now by operating the automatic ignition switch 127, the output of the automatic ignition device 128 will generate an electric arc at the electronic ignitor 126 and thereby ignite the gas coming out of the pilot-flame burner 125.

When the gas operation unit 123 is subsequently brought into the second open stage II, the main-flame gas output end 122 is opened, and a relatively large amount of gas is delivered to the main-flame gas nozzle 330. The gas injected from the main-flame gas nozzle 330 into the main-flame burner box 310 will be ignited at a plurality of flame holes 311 of the main-flame burner box 310 by the pilot flame of the pilot-flame burner 125.

The carbon-deposition-preventing gas burner 30 has the main-flame burner box 310, an incoming-gas guide tube 320, and the main-flame gas nozzle 330.

The main-flame burner box 310 is provided on the inner side of the burner opening 220, and the top side of the main-flame burner box 310 is formed with the flame holes 311. The main-flame burner box 310 is the main heat source of the ceramic oven 40. The main-flame burner box 310 may be a rectangular box in order to be disposed in a space-efficient manner and have a large area. To prevent carbon deposition even more effectively, the flame holes 311 may be long, narrow apertures. Moreover, the flame holes 311 may be regularly arranged at equal intervals.

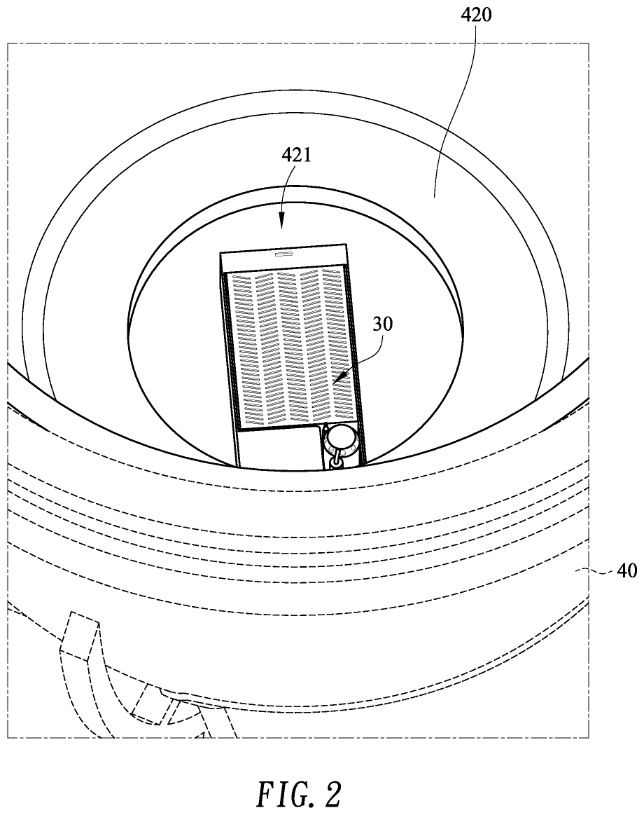

As shown in FIG. 2, FIG. 3, and FIG. 5, the flame holes 311 of the main-flame burner box 310 constitute a large combustion area that helps increase the area of contact between burning flames 340 and air, i.e., the area of secondary air input; as a result, more complete combustion can be achieved, and carbon deposition reduced or prevented. Furthermore, in order for the flames 340 generated by the carbon-deposition-preventing gas burner 30 to move upward into an inner stove 420 effectively, the main-flame burner box 310 of the carbon-deposition-preventing gas burner 30 is provided under an inner-stove opening 421 of the inner stove 420.

The incoming-gas guide tube 320 is provided on one side of the main-flame burner box 310 and is in communication with the main-flame burner box 310. The incoming-gas guide tube 320 is provided to allow the gas entering the main-flame burner box 310 to be distributed evenly, the objective being to create a smooth gas flow in the main-flame burner box 310 so that the main-flame burner box 310 can work effectively.

The main-flame gas nozzle 330 is provided at the gas inlet of the incoming-gas guide tube 320 and is in communication with the main-flame gas output end 122. The main-flame gas nozzle 330 can output different amounts of gas under the control of the gas operation unit 123, in order for the main-flame burner box 310 to generate different levels of heat, and hence for the operation of the ceramic oven 40 to better meet user needs.

For the safety of use, the gas controller 120 further has a safety control valve 129 for receiving the heat-level signal of a heat sensor 331 provided adjacent to the main-flame burner box 310 of the carbon-deposition-preventing gas burner 30 and/or the pilot-flame burner 125, and for cutting off the output of gas from the main-flame gas output end 122 and/or the pilot-flame gas output end 124 when the heat-level signal is lower than a predetermined temperature value (indicating that the carbon-deposition-preventing gas burner 30 and/or the pilot-flame burner 125 is not in the combustion state), thereby ensuring the safety of use.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A gas stove structure capable of preventing carbon deposition, comprising:
a control box comprising:
a control box housing configured to cover an oven opening; and
a gas controller provided in the control box housing, the gas controller having:
a gas input end extending out of the control box housing;
a main-flame gas output end; and
a gas operation unit having an operation end provided on the control box housing, wherein the gas operation unit is configured to control a state of communication between the gas input end and the main-flame gas output end;
an extending support frame formed as a box and having a plurality of vent holes, wherein the extending support frame has one end coupled to an inner side of the control box housing and an opposite end provided with a burner opening; and
a carbon-deposition-preventing gas burner having:
a main-flame burner box provided on an inner side of the burner opening, wherein the main-flame burner box has a top side formed with a plurality of flame holes;
an incoming-gas guide tube provided on one side of the main-flame burner box and in communication with the main-flame burner box; and
a main-flame gas nozzle provided at a gas inlet of the incoming-gas guide tube and in communication with the main-flame gas output end.

2. The gas stove structure capable of preventing carbon deposition as claimed in claim 1, wherein the control box housing has one side formed as a curved structure.

3. The gas stove structure capable of preventing carbon deposition as claimed in claim 1, wherein the main-flame burner box is a rectangular box.

4. The gas stove structure capable of preventing carbon deposition as claimed in claim 1, wherein the flame holes are long, narrow apertures.

5. The gas stove structure capable of preventing carbon deposition as claimed in claim 4, wherein the flame holes are regularly arranged at equal intervals.

6. The gas stove structure capable of preventing carbon deposition as claimed in claim 1, wherein the gas controller further has a pilot-flame gas output end, the gas operation unit is further configured to control a state of communication between the gas input end and the pilot-flame gas output end, and a pilot-flame burner is provided on a lateral side of the main-flame burner box and is in communication with the pilot-flame gas output end.

7. The gas stove structure capable of preventing carbon deposition as claimed in claim 6, wherein an electronic ignitor is provided on a lateral side of the pilot-flame burner, and the control box housing further has an automatic ignition switch for controlling an automatic ignition device in the control box housing in order for the electronic ignitor to ignite gas coming out of the pilot-flame burner.

8. The gas stove structure capable of preventing carbon deposition as claimed in claim 6, wherein the gas operation unit comprises a pilot-flame control stage for controlling the amount of gas output from the pilot-flame gas output end of the gas controller to the pilot-flame burner and a main-flame control stage for controlling the amount of gas output from the main-flame gas output end of the gas controller to the main-flame gas nozzle.

9. The gas stove structure capable of preventing carbon deposition as claimed in claim 6, wherein the gas controller has a safety control valve for receiving a heat-level signal of a heat sensor provided adjacent to the main-flame burner box and/or the pilot-flame burner, and for cutting off gas output from the main-flame gas output end and/or the pilot-flame gas output end when the heat-level signal is lower than a control value.

10. The gas stove structure capable of preventing carbon deposition as claimed in claim 1, wherein the control box housing has a housing bottom side provided with a fixing clamp plate, and the fixing clamp plate is configured to be coupled to the housing bottom side by a turning knob.
